(19) United States
(12) Patent Application Publication
(10) Pub. No.: US 2007/0272048 A1
(43) Pub. Date: Nov. 29, 2007

(54) Variable Speed Gear Transmission

(76) Inventor: Arthur Vanmoor, Boca Raton, FL (US)

Correspondence Address: LERNER GREENBERG STEMER LLP, P O BOX 2480, HOLLYWOOD, FL, 33022-2480, US

(21) Appl. No.: 11/460,667

(22) Filed: Jul. 28, 2006

(30) Foreign Application Priority Data
May 25, 2006 (NL) NL 1031887

(51) Int. Cl. F16H 3/22

(52) U.S. Cl. 74/348

(57) ABSTRACT

An infinitely variable speed gear transmission transmits a torque from an input shaft to an output shaft. A conical member is mounted to the input shaft and it is formed with a helical gear. A rider wheel formed with worm gear toothing meshes with the helical gear on the conical member. The rider wheel is mounted for rotation about an axis substantially orthogonal to said input rotational axis of the input shaft and for translation along said peripheral surface of the conical member. The output shaft is directly or indirectly coupled with a form lock to the rider wheel.

### BACKGROUND OF THE INVENTION

1. Field of the Invention

The invention relates to a mechanical power transmission apparatus. More specifically the invention pertains to an infinitely variable speed gear transmission.

2. Description of the Related Art

A variety of variable speed transmissions are known in the mechanical arts. Especially automotive technology is intimately interested in developing variable speed transmissions that are suitable for the high-torque applications found there. Currently, virtually all automotive transmissions used in automobiles, light and heavy trucks, as well as motorcycles used stepped gear transmissions with discrete gear steps defined by the gear ratios of the respectively meshing gear wheels.

One type of infinitely variable speed transmission uses one or more conical transmission elements. There, the infinitely variable radius of the cone—from rₘₐₓ to rₘᵢₙ—provides for an infinitely variable transmission ratio within the boundaries of the maximum and minimum radii of the conical element.

By way of example, U.S. Pat. No. 6,524,214 B1 describes a variable ratio transmission with a conical power transmission element mounted directly on an input drive shaft. A pickup element in the form of a spur wheel (output roller drive disk) is mounted to an output drive shaft. The output shaft is oriented parallel to the peripheral surface of the conical element on the input drive shaft. The rider disk rides on the surface of the conical element. The power is transmitted by a force lock between the spur wheel, or rider disk: and the conical element, i.e., by a frictional force between the circumferential surfaces of the two elements. As the rider disk is moved up or down on the output shaft, it contacts the conical element at locations with different circumferences, i.e., different radii.

A similar type of transmission is described in U.S. Pat. No. 5,653,143. There, the power transmission between the conical element and the rider disk is effected by a meshing relationship. The peripheral surface of the conical element is formed with longitudinal gearing formed to mesh with the spur wheel rider, which is formed with a corresponding gear toothing. Further, the conical element is used as the output element and the rider wheel is used as the input element. The rider wheel is mounted to a spindle drive with which it is moved along the output shaft, thus varying the transmission ratio between the input and output shafts infinitely.

A slight variation to the same principle is illustrated in U.S. Pat. No. 5,425,685. There, the conical element is formed with longitudinal gearing grooves on a jacket surface that is convexly rounded as seen in longitudinal section. That is, the radius of the conical element increases more steeply as the rider gear wheel approaches the larger diameter portion of the conical element. The rider wheel connects to the output shaft via a universal joint, which allows the output shaft to be oriented parallel to the rotational axis of the conical element.

The above-described transmission systems have in common that the input and output shafts are oriented (approximately) parallel, so that the conical element and the rider element rotate about (approximately) parallel axes. They belong therefore, to a class of gears generally referred to as spur gears. A second group of infinitely variable power transmission assemblies is characterized by input and output shafts that are oriented transverse to one another. The conical element of the second group is provided with a helical toothing and helical gearing grooves. These gears belong to a class generally referred to as worm gears.

Reference is had by way of example, to U.S. Pat. No. 3,422,702. There, a torque from a rotating input shaft is transmitted through various universal joints to an input gear, which transmits to an idler carrier with internal gearing. A plurality of idler carriers are selectively engaged with a conical element that is mounted on an output shaft. The idlers rotate about an axis that extends transversely to the conical element and approximately parallel to the respective orientation of the helical gear toothing on the conical element. The helical gear of the conical element has an increasingly steeper angle, i.e., an increasing screw lead, from the large diameter to the small diameter of the cone.

### SUMMARY OF THE INVENTION

It is accordingly an object of the invention to provide a variable speed gear transmission which overcomes the disadvantages of the heretofore-known devices and methods of this general type and which provides a high-efficiency, easily variable transmission assembly.

With the foregoing and other objects in view there is provided, in accordance with the invention, an infinitely variable speed gear transmission, comprising:

a conical member forming an input element rotatably mounted about an input rotational axis, said conical member having a rotationally symmetrical peripheral surface formed with helical gearing;

a rider wheel formed with worm gear toothing configured to mesh with said helical gearing on said conical member, said rider wheel being mounted for rotation about an output rotational axis having a variable orientation relative to said input rotational axis and for translation along said peripheral surface of said conical member;

an output shaft coupled with a form lock to said rider wheel.

In accordance with an added feature of the invention, the rider wheel is disposed to move along the peripheral surface in a direction substantially parallel to the conical member in one plane and to mesh with the helical gear at a plurality of locations defined along the conical member.

In accordance with an alternative feature of the invention, the conical member is in form lock with the input shaft so as to rotate therewith and mounted to be transitionally movable along the input shaft. It will be understood that the relative movement of the two members (conical element, rider wheel) is of the essence in this context

In accordance with an additional feature of the invention the conical member is formed with a curved peripheral surface having a rotationally symmetric periphery about the input rotational axis. Any curvature may be possible, depending on the application and the desired variation gradient in the gear ratio relative to the movement of the elements. In a preferred embodiment, the peripheral surface is convexly curved in longitudinal section of the conical member. In a further preferred embodiment, the convex curve of the peripheral surface follows a circular arc with a given radius, and the rider wheel has a radius smaller than the given radius of the convex curve to at least a factor of 2 and at least 5, or more.

In accordance with another feature of the invention, the conical element forms a part of a roller cup formed with a toroidal void and having a variable-lead gear formed on a convex inner surface of the toroidal void, the variable-lead gear including the helical gear of the conical element and transitioning towards a peripheral wing portion of the roller cup.

In accordance with a concomitant feature of the invention, the toroidal void in the roller cup is formed with a circular arc cross-section.

It will be understood that the term “infinitely” as used herein pertains to the stepless or substantially stepless variation of the transmission ratio within a given range only. The range is bounded by the extremes (maximum, minimum) of the radius of the transmission member referred to as the conical element or as the roller cup.

Other features which are considered as characteristic for the invention are set forth in the appended claims.

Although the invention is illustrated and described herein as embodied in a variable speed gear transmission with infinitely variable transmission ratio, it is nevertheless not intended to be limited to the details shown, since various modifications and structural changes may be made therein without departing from the spirit of the invention and within the scope and range of equivalents of the claims.

The construction of the invention, however, together with additional objects and advantages thereof will be best understood from the following description of the specific embodiment when read in connection with the accompanying drawings.

### BRIEF DESCRIPTION OF THE DRAWING

FIG. 1 is a simplified elevational view illustrating the principles underlying the transmission assembly according to the invention.

FIG. 2 is a diagram illustrating a side elevation of a conical member and a rider wheel in four different operating positions;

FIG. 3 is a diagrammatic side elevational view of an exemplary embodiment of the variable speed gear transmission apparatus according to the invention;

FIG. 4 is a similar view of a modification of the exemplary embodiment of the variable speed gear transmission apparatus shown in FIG. 3;

FIGS. 5-8 are elevational side views of several modifications of a power output rider gear wheel;

FIG. 9 is a diagrammatic side view of a further exemplary embodiment of the transmission apparatus with infinitely variable gear ratio; and

FIG. 10 is a partial, diagrammatic view of a meshing relationship between a conical element and a pickup gear.

### DESCRIPTION OF THE PREFERRED EMBODIMENTS

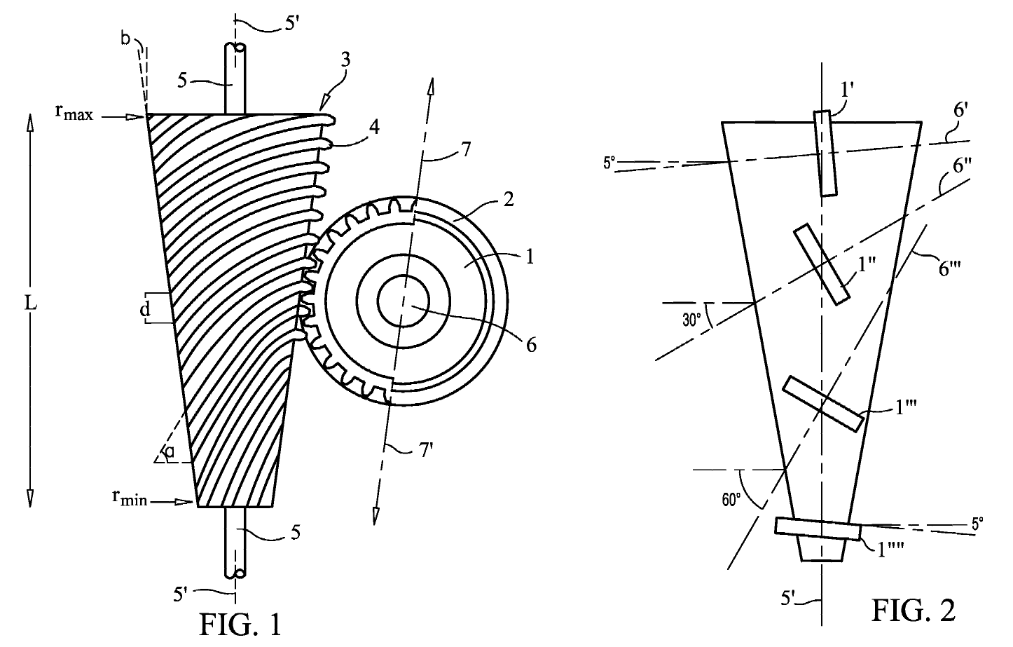

Referring now to the figures of the drawing in detail and first, particularly, to FIG. 1 thereof, there is seen a rider wheel 1 with a substantially longitudinal gear toothing 2 riding on and meshing with a helical toothing 4 on a conical element 3. The conical element 3 is mounted to an input shaft 5 which is connected to a driving power plant, such as an internal combustion engine or an electrical motor, whose output power is transmitted from the input shaft 5, through the conical element 3 and the rider wheel 1, to an output shaft 6 coupled to the rider wheel 1 The rider wheel 1 will thus be referred to in the following as the output wheel 1. The output shaft 6, and with it the output wheel 1, are movable in parallel with the periphery or the jacket surface of the conical element 3, as indicated by the arrows 7 and 7′.

It will be understood that it is only important for the two elements 1 and 3 to be moved relative to one another. That is, it is equally possible for the conical element to be moved along an axis defined by the input shaft 5. In that case, the output wheel 1 would only have to be moved horizontally sideways (with reference to the drawing) in order to make up for the diameter changes as the conical element 3 moves vertically. One possibility of enabling the vertical movement of the conical element would be to provide longitudinal key gearing to the input shaft and corresponding key gearing to the conical element. In that case, the two elements 3 and 5 would be in constant form lock, positive lock, in rotational terms, but the conical element 3 could be moved longitudinally (up and down translation) on the input shaft 5.

The gear toothing 2 on the output wheel 1 is structured so as to exactly match the helical gearing 4 on the conical element 3 because the meshing relationship between the gears 2 and 4 is the sole power transmission channel from the input shaft 5 to the output shaft 6. As the conical element 3 is rotated, and the helical gearing 4 meshes with the gear toothing 2, a torque is injected into the output wheel 1. The rotation of the conical element 3, depending on the rotational direction drives the output wheel 1 either in clockwise or anti-clockwise direction. The gear toothing 2 is formed so that at least one, but preferably three, or even five, teeth engage in grooves of the helical gearing 4 at any one time. The spacing d between the teeth and the width of the grooves, i,e., the pitch of the helical gearing 4, remains constant from the large diameter rₘₐₓ of the conical element 3 to the small diameter rₘᵢₙ. The lead angle α—i.e., the angle a of the gearing 4 relative to the horizontal, or orthogonal to the input shaft 5—increases steadily from the large diameter section rₘₐₓ to the small diameter section rₘᵢₙ. It can be shown that, with the pitch remaining constant, the incremental increase in the lead angle α from rₘₐₓ to rₘᵢₙ is directly proportional to a cone angle β. This may be expressed as:

$$β = S {\int }_{{r}_{max}}^{{r}_{min}} d α d l$$

where dα is the differential change in the lead angle, dl is the length differential that is summed to the length L of the cone from rₘₐₓ to rₘᵢₙ, and S is a proportionality factor.

The relative orientations of the input and output shafts, and of the rotational axes of the various transmission elements are quite important in the context of this application. Expressions such as “parallel” are to be understood in a three-dimensional sense. That is, if two lines are said to be parallel, there exists one common plane within which both lines lie. When two lines are said to be orthogonal, they lie in respective planes that intersect one another perpendicularly. The qualifier “substantially” allows deviations from the exact placement of, say, several percent (e.g., 5%, 10%, 20%, as the case may be). The amount of deviation, however, must be understood with reference to the respective functional context and the definition should be understood as it would be understood by a person of ordinary skill in the pertinent art.

Referring now to FIG. 2, the axis or shaft orientation and, more importantly, the orientation of the gearing on the conical element 3 and the output wheel 1, respectively, is extremely important in this case. The uppermost position of the output wheel 1—here identified as the gear wheel 1′—shows the incline of its rotational axis 6′ represented by the shaft 6 at 5° relative to the orthogonal to the rotational axis 5′ of the shaft 5. The 5′ degree inclination corresponds with the inclination of the helical gearing 4 at that location. That is, the line 6′ corresponds with the tangent of the helical gearing 4 at the meshing location with the gear wheel 1′. As the rider wheel 1 is moved downwardly, its orientation relative to the conical element 3 is further inclined, because the angle of the helical gearing 4 increases. The wheel 1″ is shown with its axis 6″ of rotation inclined 30° from the horizontal, i.e., from the orthogonal to 5′. The wheel 1′″ is shown inclined 60° and the wheel 1′″ is shown inclined 85°. The axis 6″″ is thus nearly parallel with the axis 5′. For simplicity of the illustration and explanation, the uppermost location of the wheel would have its axis 1′ drawn horizontally—with the helical gearing 4 at a zero pitch—and the lowermost location of the wheel would have its axis 1″″ drawn vertically and parallel to the axis 5′.

The interesting result, here, is that the uppermost wheel 1′ interacts with the conical element 3 in a pure spindle drive relationship. As the wheel is moved downward, and the relative orientation of axes 5′ and 6′-6″″ changes from orthogonal towards parallel, the interaction increasingly takes on the nature of a spur gear relationship. The lowermost position, therefore, has the wheel 1″″ and the bottom portion of the conical element 3 mesh like two spur gears would.

The implementation of a cage carrier and of moving and inclining the shaft 6 is not at issue here. Various possibilities exist and the person of ordinary skill in the mechanical arts will have at his avail a plethora of options. Reference is had, by way of example, to the above-identified prior art patents which show several variable angle shaft joints and constant velocity joints. It is furthermore clear that the orientation of the wheel 1 is only important relative to the conical element 3. That is, it is equally possible to change the orientation of the element 3 and to maintain the shaft 6 stationary, or to implement a combination of the two.

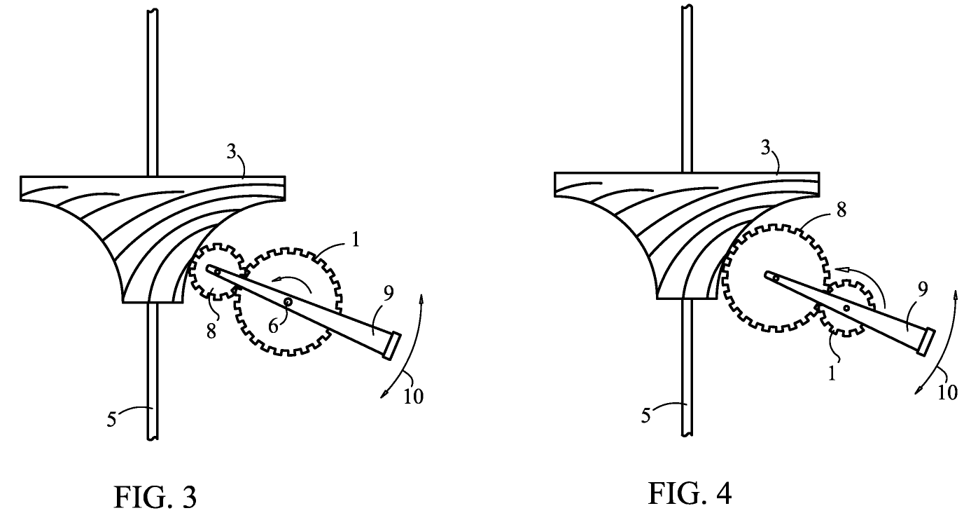

Referring now to FIG. 3, there is illustrated an exemplary embodiment of a power transmission assembly according to the invention. The conical element 3 has a convex jacket surface, as seen in longitudinal section. The focal point of the convex curve—here a circular arc—is located at the rotational axis of the gear wheel 1, i.e., at the output axle 6. An intermediate rider wheel 8 transmits the power from the conical element 3 to the output wheel 1. For that purpose, the rider wheel 8 is formed with gear toothing that is structured to mesh with to the helical gear 4 on the conical element 3 and with the gear toothing 2 on the output wheel 1. The radius of the rider wheel 8 is smaller than the radius of the convex curve by a factor of more than 5. The intermediate rider wheel 8 is mounted to a pivot arm 9, which is articulated about the output shaft. Pivoting of the pivot arm 9, as indicated by the two-sided arrow 10 moves the intermediate rider wheel 8 between different positions on the jacket of the conical element 3.

The two wheels 1 and 8 are shown in a spur gear assembly. Here, the pickup and power transmission away from the rider wheel 1 is effected by spur gear, because this is the type of gearing with the best efficiency. Other power output trains are possible as well, however, and the wheels 8 and 1 are to be considered as simplified and diagrammatic only. The gear ratio between the wheels 8 and 1 is constant and it is defined by the meshing diameters of the two wheels. The gear ratio between the two parallel wheels is directly proportional to their radii, because the circumference (U=2πr) is directly proportional to the radii.

The gear ratio between the conical element 3 and the rider wheel 8 on the other hand, is infinitely variable from the small diameter (with the pivot arm approximately horizontal in FIG. 3) to the large diameter (with the pivot arm 9 approximately vertical) of the conical element 3. The gear ratio is defined by the lead angle α at the location at which the rider wheel 8 engages the helical gear 4. The lead of a helical thread is defined as the relative advance of the thread upon one complete revolution. This, in a meshing relationship as between the helical gear 4 and the transversely rotational, intermediate rider wheel 8, is equal to the circumferential advance of the wheel 8. Assuming, for example, a lead angle α of 30° and a cone diameter of 2r=100 mm, then the lead L of the thread at that point is:

L=2πr·tan α=314.16·0.577=181.38 mm

### Assuming, furthermore, a diameter of the intermediate wheel 8 of, say, 50 mm (U=157.08 mm), then the gear ratio between the input shaft and the intermediate wheel is

$$\frac{181.38}{157.08} = 1.155$$

and one full rotation of the input shaft 5 causes 1.155 revolutions (415,7°) of the intermediate gear 8. In the illustration of FIG. 3, where the intermediate wheel 8 has a pitch circle diameter that is considerably smaller than the pitch circle of the output wheel 1, the transmission from the input shaft 5 to the output shaft 6 is a step-down transmission of approximately 1:4.

The illustration of FIG. 4 shows a larger diameter intermediate wheel 8, and an output wheel 1 with the same diameter. In this case, the transmission ratio is defined entirely by the pitch circle ratio between the conical element 3 and the intermediate wheel 8, as the ratio between the wheels 8 and 1 is 1:1

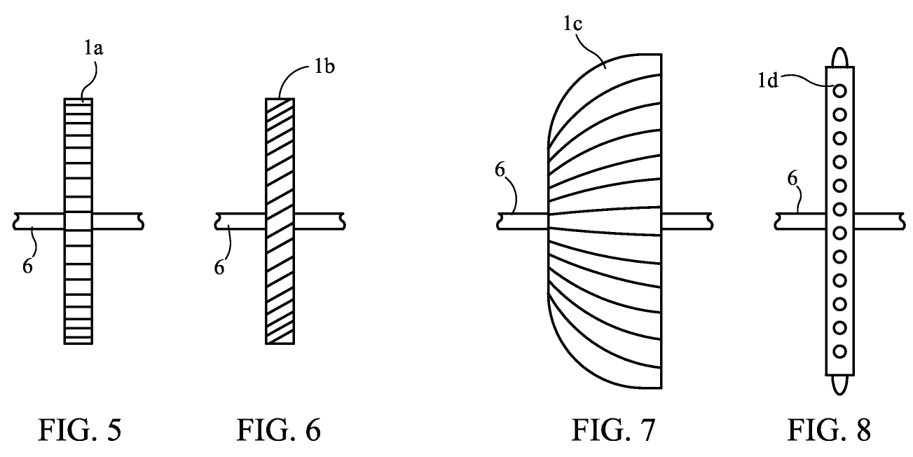

FIGS. 5 to 8 illustrate several variations of gear toothing for the rider wheel 8 and the output wheel 1. These variations lie within the purview of the person of ordinary skill in the art. A multitude of additional variations are available.

The rider gear wheel 1 of FIG. 7 deserves special mention, however. Here, the gearing 1c is located on a convexly rounded jacket surface. As the gearing is oriented in a star shape, with the axis of the shaft 5 forming the origin, the spacing distance between the teeth and/or grooves of the gearing 1c increase from the smaller diameter end to the larger diameter end of the wheel. The allows a further variation in the power transmission gearing relationships. The spacing between the thread teeth, i.e., the thread pitch, on the conical element 3 may vary. For example, the pitch may increase as the diameter of the conical element 3 decreases. Reference is had, in this regard., to the diagrammatic illustration in FIG. 12. In order to mesh at the upper end of the threaded section, i.e., at the large diameter of the conical element 3 the rider wheel 1 would be shifted so that the narrow-thread side of the wheel (i.e., the small-diameter side) meshes with the gearing on the conical element 3. As the rider wheel 1 is moved downward towards the smaller diameter section of the conical element 3, it is simultaneously shifted to its wider-thread side. This ensures proper meshing between the gears at all positions. The added variability in terms of the gear ratio is easily controlled in that the lateral position (i.e., the respective pitch circle) of the wheel 1 and its gearing 1c must be taken into account as well.

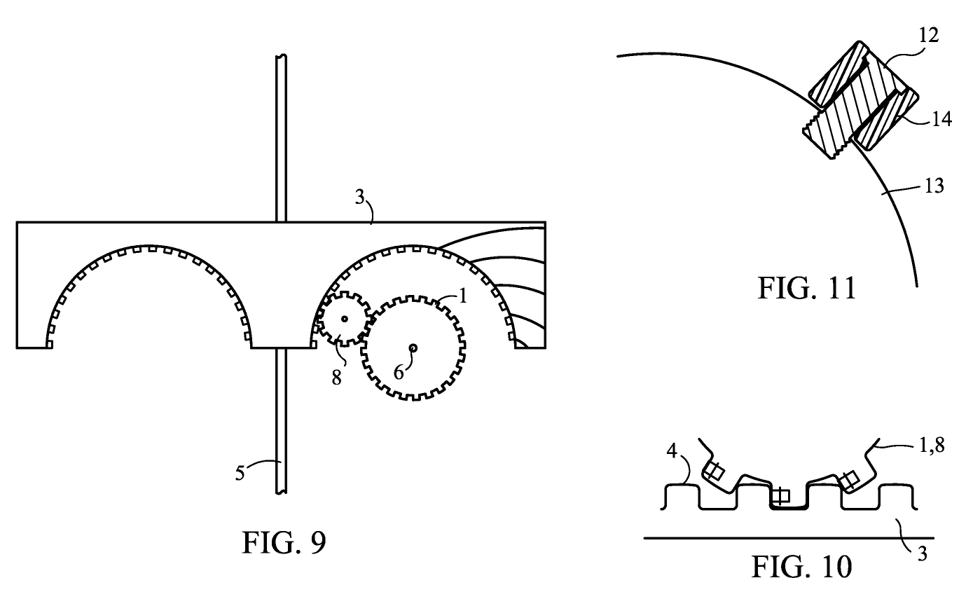

FIG. 9 shows a further exemplary embodiment of the invention. Here, a rotation of the input shaft in one direction can be transmitted and converted into two rotational directions of the output shaft. The gear ratio can be infinitely varied from a positive maximum (e.g., 9:30 am), through a neutral position (e.g., 12 o'clock), and to a negative maximum (e.g., 2:30 pm). The conical element 3, for that purpose, is formed with “wings” towards the outside that are geared towards an opposite lead as opposed to the center cone. In the embodiment of FIG. 9 the power injection element is better referred to as a roller cup 11 with a single roller depression., a toroidal void. The “helical gearing” on the roller cup 11 has two different lead angles. As shown, the thread direction on the outside wing is oriented opposite the lead angle on the inside conical portion. When the intermediate wheel meshes at the outside location (e.g., 2 o'clock), the output shaft will rotate in a direction opposite from when the intermediate wheel 8 meshes with the conical element inside (e.g., 10 o'clock). The neutral lead angle is set at the upper position (12 o'clock) where the lead changes from left to right orientation. It should be understood that the neutral position may also be formed other than in the center of the arc. This would provide more detailed variation of the gear ratio in one direction than in the opposite direction, similar to a typical automotive transmission with considerable variability in the forward direction and reduced variability in the backward direction.

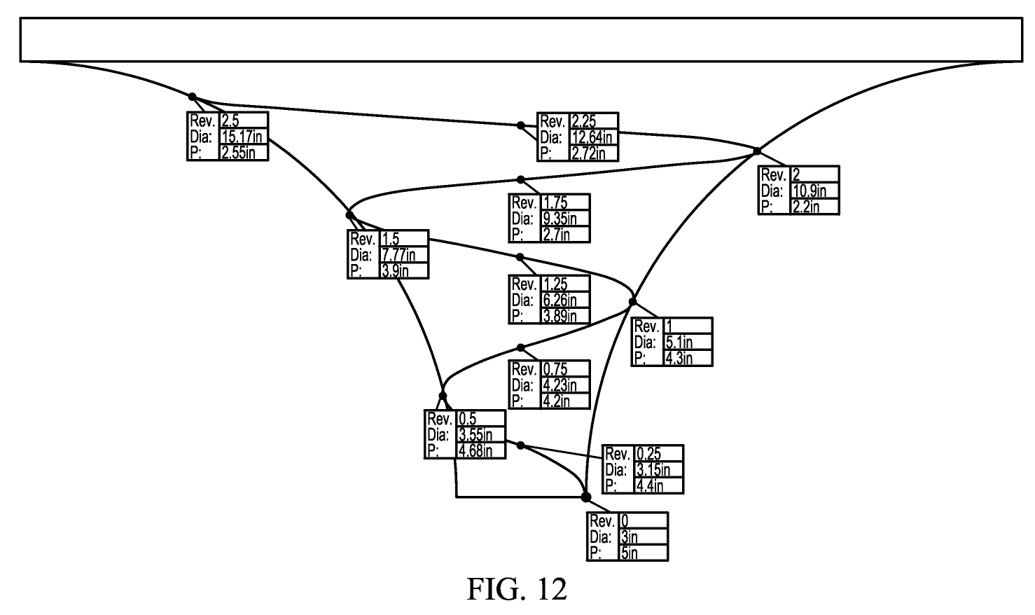

The meshing between the helical gear on the conical element 3 or on the roller cup 11 and the rider wheel (either the intermediate wheel 8 or the output wheel 1) places great frictional stress on the system. This may be alleviated by introducing rollers roller races roller balls or the like in the flanks of the rider wheel. Similarly, super-resistant layers of PTFE (polytetrafluoroethylene, Teflon®) or similar friction reduction materials may be placed on the elements at strategic locations. Reference is had to FIG. 10, for example which illustrates such an embodiment in highly diagrammatic fashion. A roller wheel 9 is integrated on a flank of the gear toothing of the rider wheel 1 or 8. Where the transmission has a preferred drive direction, it may suffice to dispose the friction-alleviating means on only the one flank.

An additional embodiment of a friction-alleviation system is illustrated in FIG. 11. Here, the gear teeth of the rider wheel 1 or 8 are formed by pins 12 that project radially from the body 13 of the wheel. A roller sleeve 14 of low-friction material rides on the pin 12 so that a roller is formed that rotates about the axis of the pin 12. The axis extends radially towards the center of the wheel 1, 8. It is an advantage of this configuration that the tooth profile of the wheel gearing can be easily defined by the cross-sectional profile of roller sleeve 14. Also, as the pin 12 is preferably screwed into the body 13 of the wheel, the roller sleeves 14 can be replaced relatively easily.

The diagrammatic view of the conical element 3 illustrated in FIG. 11 is described above with reference to the embodiment of FIG. 7. In addition it should be noted that the concavity of the conical element 3 may be defined by other curves than a circular arc. It may, for instance, follow a hyperbola or a partial tangent curve, or the like. The indicated dimensions are for illustrative purposes only and they are not necessarily representative of a realistic implementation of the invention.

I claim:

1. An infinitely variable speed gear transmission, comprising:
a conical member forming an input element rotatably mounted about an input rotational axis, said conical member having a rotationally symmetrical peripheral surface formed with helical gearing;
a rider wheel formed with worm gear toothing configured to mesh with said helical gearing on said conical member, said rider wheel being mounted for rotation about an output rotational axis having a variable orientation relative to said input rotational axis and for translation along said peripheral surface of said conical member;
an output shaft coupled with a form lock to said rider wheel.

2. The transmission according to claim 1, wherein said rider wheel is disposed to move along said peripheral surface in a direction substantially parallel to an outer jacket surface of said conical member in one plane and to mesh with said helical gear at a plurality of locations defined along said conical member, wherein said rider wheel is oriented with a central plane intersecting said input rotational axis with a near parallel orientation at one location and a near perpendicular orientation at a location distal from the one location, and wherein an inclination of said rider wheel relative to said input rotational axis increases steadily from the near perpendicular orientation to the near perpendicular orientation.

3. The transmission according to claim 1, which comprises an input shaft in form lock with said conical member so as to rotate therewith, and wherein said conical member is mounted to be translationally movable along said input shaft.

4. The transmission according to claim 1, wherein said conical member is formed with a curved peripheral surface having a rotationally symmetric periphery about said input rotational axis.

5. The transmission according to claim 4, wherein said peripheral surface is convexly curved in longitudinal section of said conical member.

6. The transmission according to claim 5 wherein a convex curve of said peripheral surface follows a circular arc with a given radius, and said rider wheel has a radius smaller than said given radius of the convex curve to at least a factor of 2.

7. The transmission according to claim 6, wherein said radius of said rider wheel is smaller than said given radius of the convex curve by at least a factor of 5.

8. The transmission according to claim 4 wherein said conical element forms a part of a roller cup formed with a toroidal void and having a variable-lead gear formed on a convex inner surface of said toroidal void, said variable-lead gear including said helical gear of said conical element and transitioning towards a peripheral wing portion of said roller cup.

9. The transmission according to claim 8, wherein said toroidal void in said roller cup is formed with a circular arc cross-section.

10. The transmission according to claim 1 wherein said helical gearing has an angle of inclination increasing from substantially zero in one location to substantially 90° in another location, and wherein said rider wheel is mounted to change orientation along said conical member corresponding to said angle of inclination.
